(19) United States
(12) Patent Application Publication
(10) Pub. No.: US 2014/0129335 A1
(43) Pub. Date: May 8, 2014

(54) PRESENTING A REVIEW BASED ON A USER PURPOSE

(71) Applicant: HIPMUNK, INC., San Francisco, CA (US)

(72) Inventors: Steven Ladd Huffman, San Francisco, CA (US); Adam Julian Goldstein, San Francisco, CA (US); Christopher Brian Slowe, San Francisco, CA (US)

(73) Assignee: Hipmunk, Inc., San Francisco, CA (US)

(21) Appl. No.: 13/670,795

(22) Filed: Nov. 7, 2012

(51) Int. Cl. G06Q 30/02

(52) U.S. Cl. CPC G06Q 30/0257
USPC 705/14.58

(57) ABSTRACT

A review of a venue may be presented based on a purpose (e.g., a user purpose) by a system (e.g., a suitably programmed machine). In particular, the system may identify a purpose of a user (e.g., a first user purpose) for being within a city. The system may access a review of a venue that is located within the city. The review may indicate an opinion of the user with respect to the venue. The system may determine that the purpose of the user matches the purpose of another user (e.g., a second user purpose) for being within the city. Hence, the system may present the review of the venue to the other user, based on the two users having the same purpose for being within the city.

### TECHNICAL FIELD

The subject matter disclosed herein generally relates to the processing of data. Specifically, the present disclosure addresses systems and methods that involve presenting a venue based on its neighborhood, presenting a review based on a user purpose, or both.

### BACKGROUND

An online service may allow a user of the online service to view multiple options for travel plans and make a selection from among the multiple options. For example, an airline may operate a webpage that provides an online reservation service from which a user may search for available flights (e.g., from San Francisco to New York) on a particular day and then select one of the available flights for reserving a seat thereon. As another example, a hotel may operate a webpage that provides an online reservation service from which the user may search for available hotel properties and room types (e.g., in New York) for a particular period of time (e.g., September 5 through September 9) and then select one of the available room types at an available hotel property for reserving. As a further example, a restaurant may offer a webpage that provides an online reservation service from which the user may search for available tables (e.g., at a popular restaurant) within a particular range of times (e.g., 5:30 PM to 7:30 PM) on a particular date and then select one of the available tables for reserving.

### BRIEF DESCRIPTION OF THE DRAWINGS

Some embodiments are illustrated by way of example and not limitation in the figures of the accompanying drawings.

FIG. 1 is a network diagram illustrating a network environment suitable for presenting a venue based on its neighborhood, presenting a review based on a user purpose, or both, according to some example embodiments.

FIG. 2 is a block diagram illustrating components of a presentation machine suitable for presenting a venue based on its neighborhood, presenting a review based on a user purpose, or both, according to some example embodiments.

FIG. 3 is a diagram illustrating a user interface suitable for entering and submitting a query to a search engine, according to some example embodiments.

FIG. 4-5 are diagrams illustrating a user interface suitable for presenting a venue based on its neighborhood, presenting a review based on a user purpose, or both, according to some example embodiments.

FIG. 6 is a diagram illustrating a user interface suitable for providing a communication that requests submission of a review based on a user purpose, according to some example embodiments.

FIG. 7-8 are flowcharts illustrating operations of the presentation machine in performing a method of presenting a venue based on its neighborhood, according to some example embodiments.

FIG. 9-10 are flowcharts illustrating operations of the presentation machine in performing a method of presenting a review based on a user purpose, according to some example embodiments.

FIG. 11 is a block diagram illustrating components of a machine, according to some example embodiments, able to read instructions from a machine-readable medium and perform any one or more of the methodologies discussed herein.

### DETAILED DESCRIPTION

Example methods and systems involve presenting an item (e.g., a venue) based on its neighborhood, presenting a review of an item (e.g., a review of a venue) based on a user purpose, or both. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A venue may be presented based on its neighborhood within a city by a system (e.g., a machine suitably programmed by one or more software components). In particular, the system may identify a purpose of the user (e.g., a user purpose) in submitting a request for a presentation of venues that are located within the city. The system may access a database that correlates this identified purpose (e.g., business or romance) with a neighborhood that lies within the city. The system may determine a venue (e.g., for presentation, suggestion, or recommendation) based on the venue being located within a neighborhood that is correlated with the purpose. Hence, the system may present the venue to the user in fulfillment of the user's request. Additional details and features of such a system are described below.

A review of a venue may be presented based on a purpose (e.g., a user purpose) by a system (e.g., a suitably programmed machine). In particular, the system may identify a purpose of a user (e.g., a first user purpose) for being within a city. The system may access a review of a venue that is located within the city. The review may indicate an opinion of the user with respect to the venue. The system may determine that the purpose of the user matches the purpose of another user (e.g., a second user purpose) for being within the city. Hence, the system may present the review of the venue to the other user, based on the two users having the same purpose for being within the city. Additional details and features of such a system are described below.

As used herein, a “venue” refers to a place (e.g., a place of business) located within a neighborhood. In general, a venue is a place where one or more services or experiences are available (e.g., free or for payment) to users of the venue (e.g., by visiting the venue or otherwise using the venue). Examples of venues include accommodations, such as a hotel, a motel, a resort, a hostel, a bed-and-breakfast inn, a boarding house, a vacation rental, a home-share, a campground, and any suitable combination thereof. Other examples of venues include providers of hospitality services (e.g., dining services), such as a concierge, a caterer, a restaurant, a bar, a cafeteria, and any suitable combination thereof. Additional examples of venues include entertainment venues (e.g., providers of entertainment), such as a museum, an amusement park, a public park, a theater, a sports stadium, and any suitable combination thereof. Further examples of venues include commercial venues (e.g., a business, a store, a shopping center, a corporate building, a convention center, or a conference facility), educational venues (e.g., a campus, a lecture hall, or a dormitory), healthcare venues (e.g., a spa, a salon, a massage studio, a gym, a pool, a fitness center, a hospital, a clinic, or a medical office), and any suitable combination thereof.

As used herein, a “neighborhood” is a geographic area that lies within a city and constitutes a portion of the city. As used herein, a “city” refers to a geographical region that encompasses a city (e.g., San Francisco), a metropolitan area (e.g., Washington D.C.), a county, a town, a suburb, a village, a postal code, an unincorporated area, or any suitable combination thereof. A city may encompass one or more neighborhoods. For example, within the city of San Francisco, there is a neighborhood known as Chinatown, as well as another neighborhood known as Fisherman's Wharf and a further neighborhood known as Haight. Within its city, a neighborhood may be defined by one or more boundaries that are precise (e.g., specific streets or waterways), and a neighborhood may have one or more boundaries that are imprecise (e.g., a vicinity within an approximate distance of a venue or other location).

A neighborhood may be distinguished by one or more characteristics of the neighborhood (e.g., characteristics unique to the neighborhood among other neighborhoods within the same city). In some situations, a neighborhood may be fully or partially characterized by one or more venues within the neighborhood. That is, a venue may fully or partially characterize its neighborhood. For example, a group of businesses (e.g., investment banks) may characterize their neighborhood as “the financial district” within their city. As another example, an amusement park and several nearby hotels that have swimming pools and childcare may characterize their neighborhood as being “family-friendly” (e.g., in comparison to other neighborhoods in the same city). As a further example, an old building with historical significance may characterize its neighborhood as being “historic” and in some cases may influence a name of that neighborhood (e.g., “the Mission District” in San Francisco).

As used herein, a “user purpose” is a purpose of a user for being within a city (e.g., for traveling to the city, for visiting the city, for living in the city, or for any suitable combination thereof), for submitting a request for a presentation of venues that are located within the city (e.g., initiating a search for venues within the city), or for both. Examples of a user purpose include business (e.g., business trip or conference), family (e.g., family vacation or recreation for kids), romance (e.g., heterosexual or “straight” romance, or homosexual or “gay” romance), and adventure (e.g., fun or recreation for adults). In some example embodiments, the user purpose corresponds to a travel category (e.g., “singles cruises,” “wedding destinations,” or “romantic getaways”) and may be named after such a travel category. A user purpose of a user may be identified by accessing a user preference (e.g., from a user profile) of the user, receiving the user purpose from the user (e.g., via a device of the user), determining the user purpose based on behavioral information (e.g., data that describes a behavior of the user, a behavior of a socially networked friend of the user, or both), or any suitable combination thereof. As examples of determining user purposes based on behavioral information, a user that chooses to fly in business class a majority of the time is likely to be a business traveler with “business” as her user purpose, and a user whose first-degree friends all take single-traveler trips to the same destinations at the same times as the user himself is likely to be a recreational traveler with “adventure” as his user purpose.

In some example embodiments, a user purpose may be determined (e.g., inferred) based on a query submitted by a user (e.g., a traveler searching online for accommodations). For example, a suitably configured system may determine that a user whose query specifies a room for one person, arriving midweek (e.g., on Tuesday), for a one-night stay in New York City, is traveling for “business.” As another example, the system may determine that a user whose query specifies a room for two people, arriving on a Friday before a Monday holiday (e.g., a long weekend), for a two-night stay in Paris, is traveling for “romance.” As a further example, the system may determine that a user whose query specifies a room for four people (e.g., two adults and two children), arriving on a weekend (e.g., Saturday or Sunday), departing on a weekend, for a 1-week stay in Orlando, Fla., is traveling for “family.”

As used herein, an “amenity” is a feature of a venue (e.g., a feature of an accommodation). Examples of amenities include Internet access (e.g., via a wired or wireless network), parking, a pool, a gym, a fitness center, a sauna, a restaurant, a snack bar, a refreshment stand (e.g., serving tropical fruit punch and cookies), room service, a business center (e.g., with a computer, a printer, a fax machine, a scanner, and a telephone), a conference room, laundry service, childcare service, guaranteed late check-in, a non-smoking room, wheelchair access, shuttle service, and any suitable combination thereof. In various situations, a venue may charge a fee (e.g., an “amenity fee”) for use of an amenity or a combination of amenities. The amenities of a venue, along with any corresponding amenity fees, may be identified by accessing information describing the venue (e.g., a webpage, a database, an advertisement, or any suitable combination thereof). According to some example embodiments, the existence of an amenity, its corresponding amenity fee (e.g., free, $12 per use, $10 per stay, or $25 per day), or both may influence a presentation of a venue (e.g., within a ranked or sorted list of venues). Hence, a venue may be presented based on an identified amenity, its corresponding amenity fee, or both.

Although the discussion herein focuses on example embodiments in which a venue is located within a neighborhood that is within a city, one or more of the methodologies discussed herein may apply equally well to any item that has a corresponding location within a sub-region of a larger geographical region. Examples of such an item include a bottle of wine made in a particular valley within a wine-growing area, or an article of clothing made within a garment district that lies within a city.

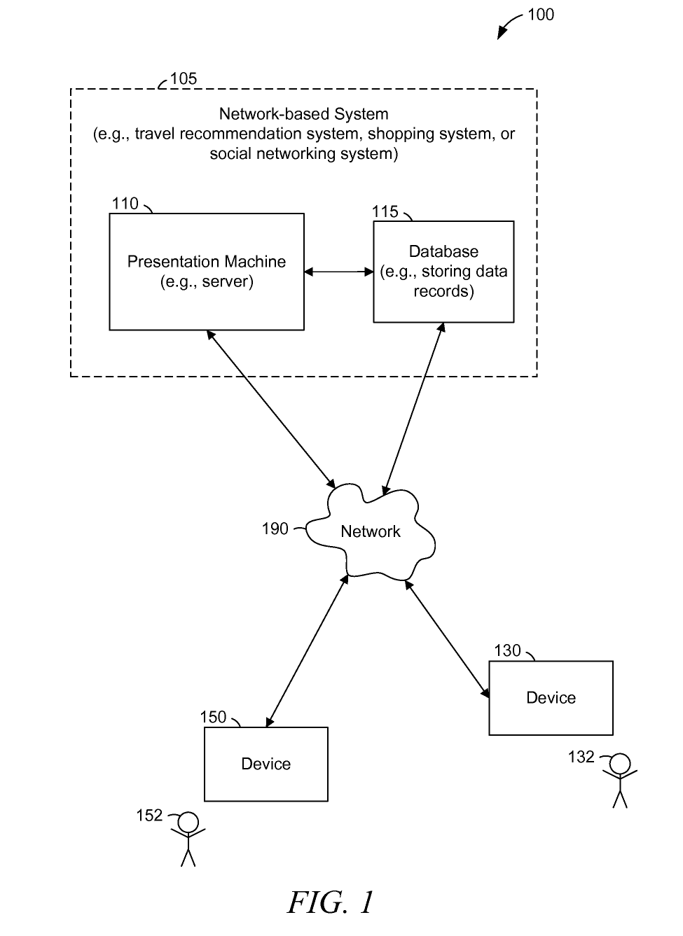

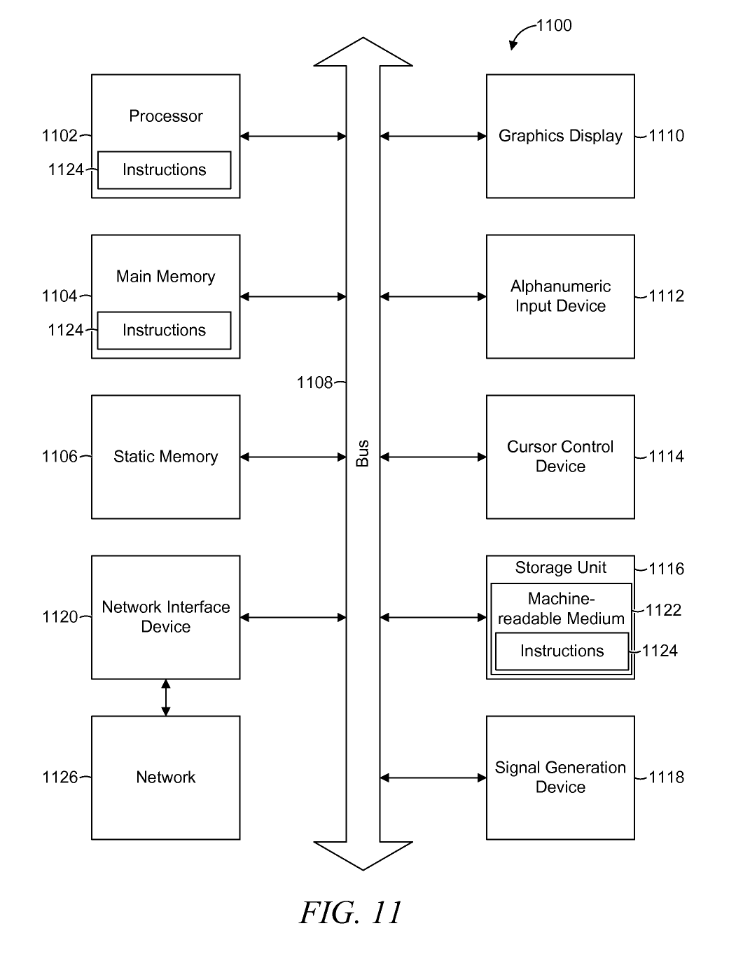

FIG. 1 is a network diagram illustrating a network environment 100 suitable for presenting a venue based on its neighborhood, presenting a review based on a user purpose, or both, according to some example embodiments. The network environment 100 includes a presentation machine 110, a database 115, and devices 130 and 150, all communicatively coupled to each other via a network 190. The presentation machine 110, the database 115, and the devices 130 and 150 may each be implemented in a computer system, in whole or in part, as described below with respect to FIG. 11.

The presentation machine 110 may be implemented as a server (e.g., a server machine) configured to provide one or more services to one or more clients (e.g., client machines, such as devices 130 and 150), one or more users, or any suitable combination thereof. The database 115 is configured to store data records for use by the presentation machine 110 in performing one or more of the methodologies discussed herein. As shown, the presentation machine 110, alone or with the database 115, may form all or part of a network-based system 105. In some example embodiments, the network-based system 105 may form all or part of a travel recommendation system, a shopping system, a social networking system, or any suitable combination thereof.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 152 is not part of the network environment 100, but is associated with the device 150. As an example, the device 150 may be a desktop computer, a vehicle computer, a tablet computer, a navigational device, a portable media device, or a smart phone belonging to the user 152.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the presentation machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

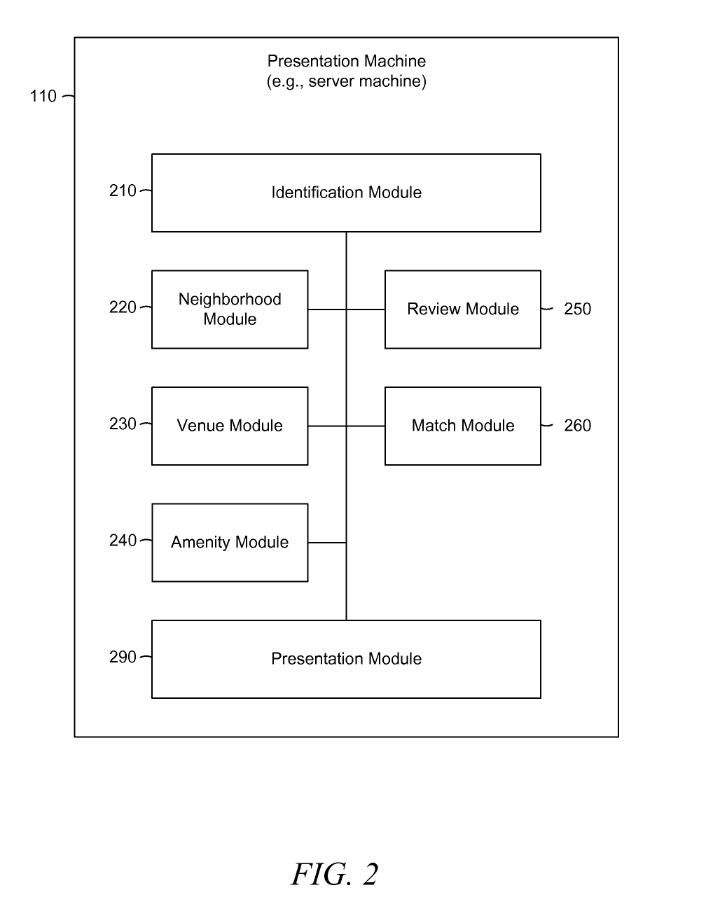

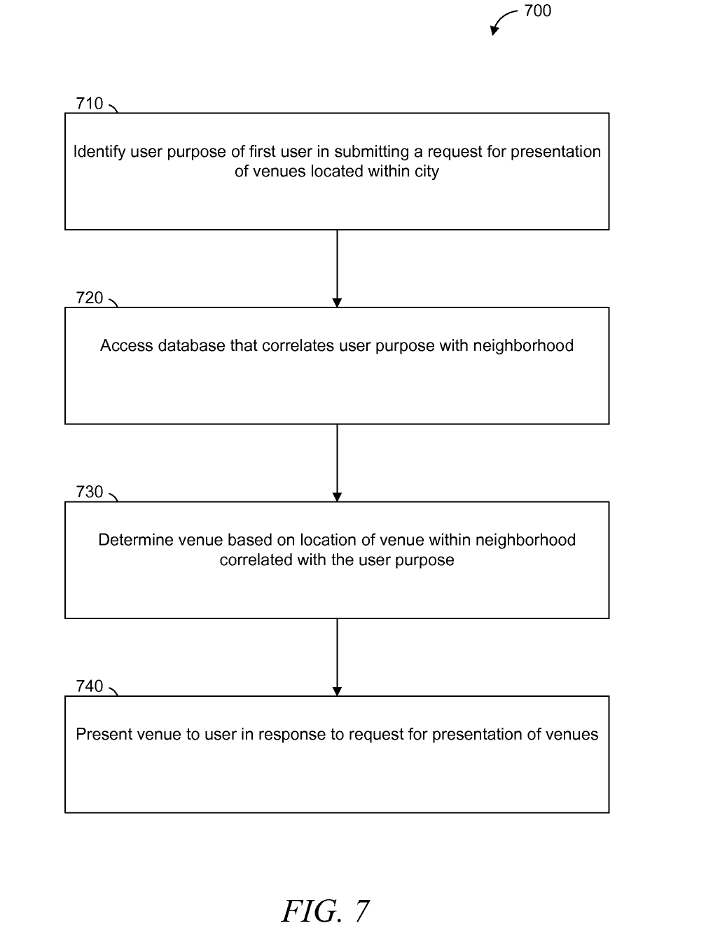

FIG. 2 is a block diagram illustrating components of a presentation machine suitable for presenting a venue based on its neighborhood, presenting a review based on a user purpose, or both, according to some example embodiments. The presentation machine 110 is shown as including an identification module 210, a neighborhood module 220, a venue module 230, an amenity module 240, a review module 250, a match module 260, and a presentation module 290, all configured to communicate with each other (e.g., via a bus, shared memory, or a switch). In example embodiments in which the presentation machine 110 is configured for presenting a venue based on its neighborhood, the presentation machine 110 may include the identification module 210, the neighborhood module 220, the venue module 230, the amenity module 240, and the presentation module 290. In example embodiments in which the presentation machine 110 is configured for presenting a review based on a user purpose, the presentation machine 110 may include the identification module 210, the review module 250, the match module 260, and the presentation module 290. Functions of various modules discussed herein are provided below with respect to FIG. 7-10.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

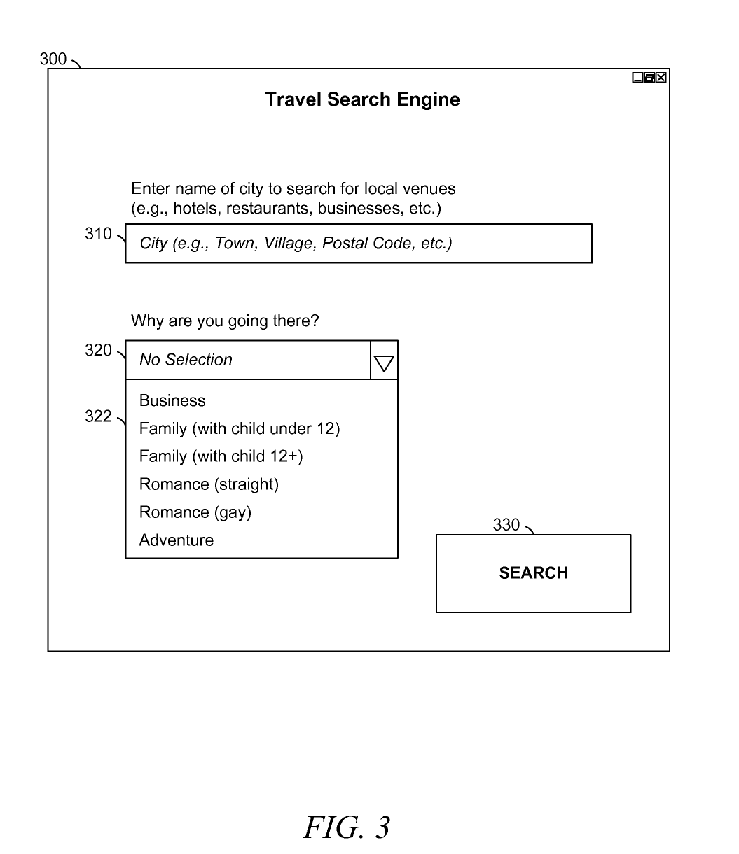

FIG. 3 is a diagram illustrating a user interface 300, which is suitable for entering and submitting a query to a search engine (e.g., a travel search engine), according to some example embodiments. The user interface 300 includes a text entry field 310 in which a user may enter a name of a city (e.g., to search for one or more local venues that are located within the city, such as hotels, restaurants, and businesses). The text entry field 310 is thus an example of an interface by which the user may enter one or more keywords or other search criteria for submission in the query to the search engine.

The user interface 300 is also shown as including a user purpose field 320 in which the user may enter a user purpose for being within the city specified in the text entry field 310. As shown in FIG. 3, the user purpose field 320 may include a pulldown menu 322 that enables the user to select a user purpose from a predefined set of user purposes (e.g., business, family with child under 12, family with child 12+, straight romance, gay romance, and adventure). In some example embodiments, the user purpose field 320 is configured to allow the user to enter a user purpose as free-form text. In some example embodiments, the user purpose field 320 is shown in a separate user interface (e.g., a user interface containing search results, rather than search criteria, for the purpose of narrowing search results).

The user interface 300 may further include a search button 330. Activation of the search button 330 may initiate a query that is based on the information specified within the text entry field 310 and in the user purpose field 320. The query may form all or part of a request for a presentation of venues that are located within the city specified in the text entry field 310. For example, the text entry field 310 may specify “San Francisco” as the city to be searched and specify “business” as the user purpose for being in San Francisco, and the search button 330 may submit a request for a presentation of venues that are located within San Francisco and that are suitable for “business” purposes.

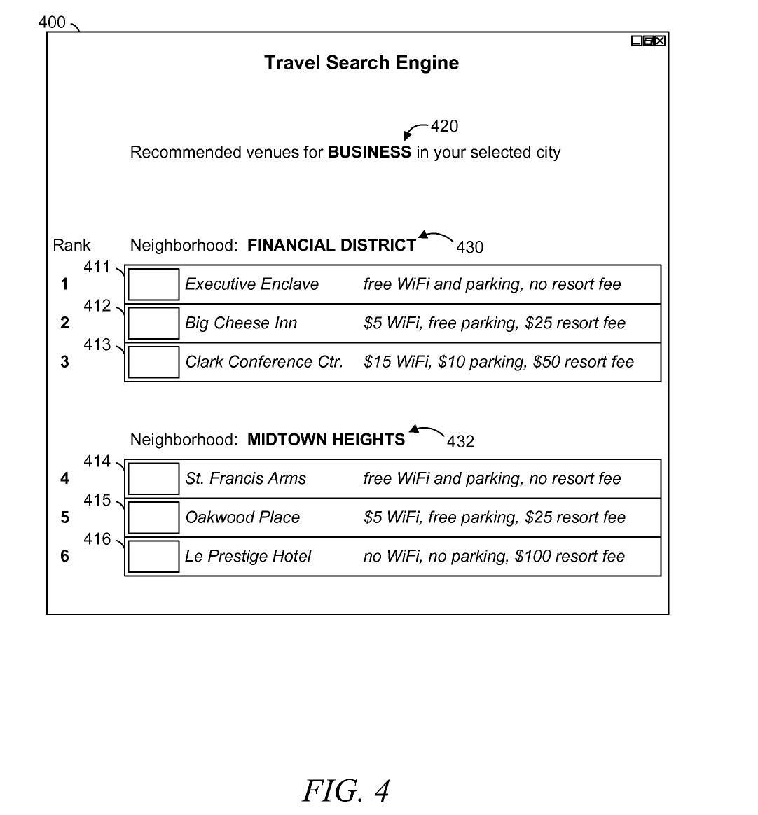

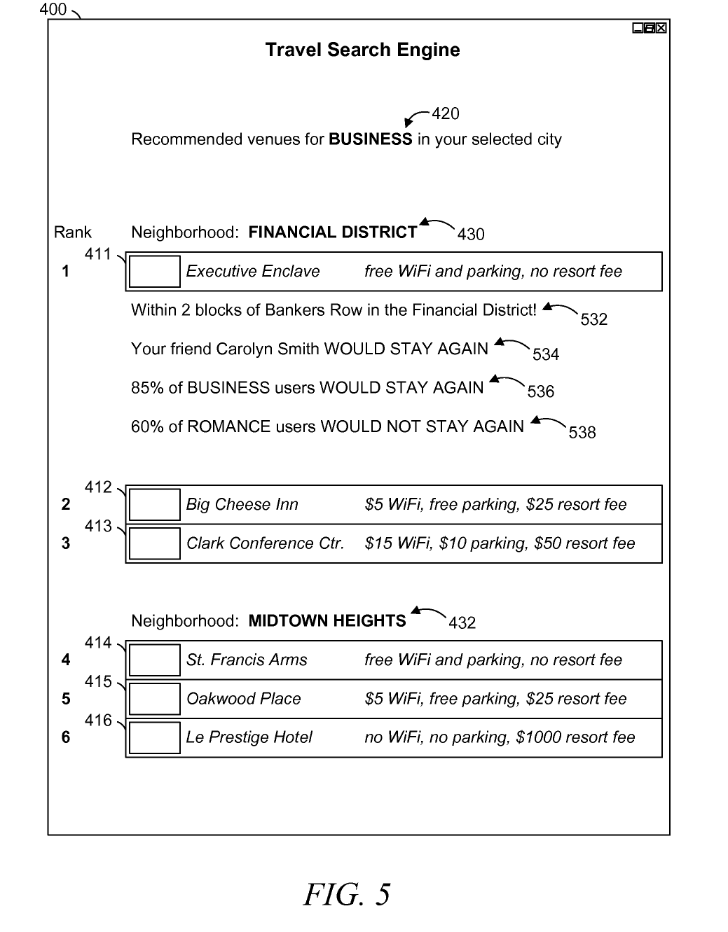

FIG. 4-5 are diagrams illustrating a user interface 400, which is suitable for presenting a venue (e.g., as a search result obtained from a query submitted to a search engine) based on its neighborhood, presenting a review (e.g., of the venue) based on a user purpose, or both, according to some example embodiments. The user interface 400 includes references 411, 412, 413, 414, 415, and 416 to venues. In some example embodiments, the references 411-416 are search results (e.g., obtained from the query entered and submitted using the user interface 300). The references 411-416 may form all or part of a presentation of venues that are located within the city. For example, the reference 411 may be a reference to a venue (e.g., a hotel named “Executive Enclave’) and may thus present the venue within the user interface 400. As shown, the references 411-416 may be ranked (e.g., sorted) based on a user purpose 420 (e.g., “business”). For example, the references 411-416 may be ranked in order of suitability for the user purpose 420. The user purpose 420 in the user interface 400 may be the same user purpose specified in the user purpose field 320 within the user interface 300.

As shown in FIG. 4-5, the user interface 400 may specify a neighborhood 430, as well as a further neighborhood 432, and the user interface 400 may indicate one or more of the specified neighborhoods 430 and 432 as corresponding to (e.g., being suitable for) the user purpose 420 (e.g., “business”). Moreover, one or more of the references 411-416 may be grouped based on their respective neighborhoods 430 and 432. In the example shown in FIG. 4-5, the references 411-413 correspond to venues that are located within the neighborhood 430 (e.g., “Financial District”), and the references 414-416 correspond to venues that are located within the neighborhood 432 (e.g., “Midtown Heights”). In some example embodiments, the neighborhoods 430 and 432 are also ranked within the user interface 400 based on the user purpose 420 (e.g., ranked in order of suitability for the user purpose 420).

According to various example embodiments, a reference (e.g., reference 411) may indicate one or more amenities of the venue to which the reference refers (e.g., the existence of one or more amenities offered by the venue), one or more prices (e.g., costs) of such amenities at the venue, or any suitable combination thereof. For example, the reference 411 may indicate that a hotel named “Executive Enclave” offers free wireless networking (e.g., WiFi), free parking, and no resort fee. Hence, the references 411-413 may be ranked based on the amenities available at their respective venues, as well as the prices thereof. Similarly, the references 414-416 may be ranked based on the amenities available at their respective venues and the prices thereof. In certain example embodiments, the neighborhoods 430 and 432 are ranked based on the amenities available at the venues within those neighborhoods 430 and 432, the prices of such amenities, or any suitable combination thereof.

In the example shown in FIG. 5, the user interface 400 may include and present additional information (e.g., information that may be presented within the user interface 400 upon an indication of interest in the reference 411, such as a mouse click or mouse over). As shown in FIG. 5, the user interface 400 may include a description 532 of the venue to which the reference 411 refers. The description 532 describes the venue and may be or include a basis (e.g., reason or contracting factor) for ranking the reference 411. In the example shown, the description 532 includes a distance (e.g., two blocks) and a reference point (e.g., a characteristic venue, such as “Bankers Row”) within the neighborhood 430 of the venue (e.g., “Financial District”).

The user interface 400 may include one or more reviews 534, 536, and 538 of the venue. The review 534 may be an individual review submitted by a user (e.g., user 152). The user that submitted the individual review (e.g., user 152) may have the same user purpose (e.g., “business”) as the user to whom the user interface 400 is presented (e.g., user 132). In the example shown, the review 534 is submitted by “Carolyn Smith,” which the review 534 indicates is a friend (e.g., a first-degree connection within a social network managed by a social networking service, such as Facebook® or Twitter®) of the user (e.g., user 132) to whom the user interface 400 is presented. The review 536 may be an aggregated review that indicates an aggregated opinion held by multiple users. In the example shown, the review 536 indicates that a majority (e.g., 85%) of users with “business” as their user purpose for being in the city would book another stay at the venue to which the reference 411 refers (e.g., “Executive Enclave”). The review 538 may be an aggregated review that indicates another aggregated opinion held by various users. In the example shown, the review 530 indicates that a majority (e.g., 60%) of users with “romance” as their user purpose would not book another stay at the venue to which the reference 411 refers (e.g., “Executive Enclave”).

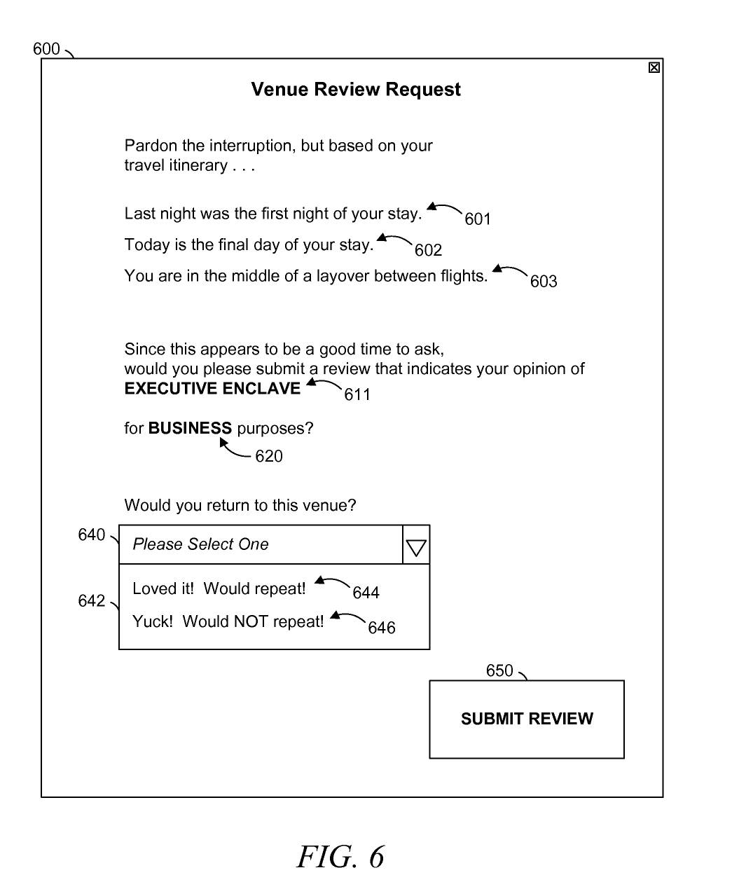

FIG. 6 is a diagram illustrating a user interface 600, which is suitable for providing a communication that requests submission of a review (e.g., of a venue) based on a user purpose, according to some example embodiments. The user interface 600 may include and present a request (e.g., a prompt, a suggestion, or a plea) that the user submit a review of the venue to which the reference 411 refers (e.g., a hotel named “Executive Enclave”). In the example shown, the user interface 600 is or includes a venue review request, and the venue review request may be based on a travel itinerary of a user (e.g., user 152 or “Carolyn Smith”).

The user interface 600 may include one or more notifications 601, 602, and 603 that are based on the itinerary of the user. The notification 601 may indicate a first night of a stay at the venue (e.g., an accommodation). In the example shown, the notification 601 indicates a first night of a stay at the venue to which the reference 411 refers (e.g., a hotel named “Executive Enclave”). The notification 602 may indicate a final day of a stay at the venue. In the example shown, the notification 602 indicates a final day of the stay at the venue to which the reference 411 refers (e.g., “Executive Enclave”). The notification 603 may indicate a time period during which the user is scheduled to experience a layover while traveling. In the example shown, the notification 603 indicates that the user (e.g., user 152 or “Carolyn Smith”) is in the middle of layover between flights. According to various example embodiments, the user interface 600 may be presented to the user at a time that is determined based on the travel itinerary of the user (e.g., after the first night of a stay at the venue, on the last day of the stay, during a layover, or any suitable combination thereof). This may have the effect of communicating a request for submission of a review of the venue at a time that is likely to be convenient for the user to respond with the requested review of the venue.

As shown in FIG. 6, the user interface 600 includes a reference 611 to the venue for which the review is being requested (e.g., a hotel named “Executive Enclave”). The user interface 600 may also include a user purpose 620 of the user from whom the review is being requested. The user purpose 620 may be determined (e.g., accessed, received, or inferred) using one or more of the methodologies discussed above. In the example shown, the user purpose 620 is “business,” and the user interface 600 may accordingly request the review of the venue from a “business” perspective (e.g., from the standpoint of a traveler visiting the venue for business purposes).

As also shown in FIG. 6, the user interface 600 may include a review entry field 640 in which a user may enter and submit a review of the venue. In the example shown, the review entry field 640 may include a pulldown menu 642 that enables the user to select a review from a predefined set of selectable reviews. In some example embodiments, the predefined set of selectable reviews offers the user a choice of one out of two or more mutually exclusive reviews (e.g., positive or negative, “like” or “dislike”, or “would repeat” or “would not repeat” or “not applicable”), while in other example embodiments, the predefined set of selectable reviews offers a spectrum or range of choices (e.g., one star, two stars, three stars, four stars, or five stars). As shown in FIG. 6, the pulldown menu 642 includes and presents a positive review 644 (e.g., “Loved it! Would repeat!”) and a negative review 646 (e.g., “Yuck! Would NOT repeat!”). In certain example embodiments, the review entry field 640 is configured to allow the user to enter a review of the venue as free-form text.

The user interface 600 may further include a review submission button 650. Activation of the review submission button 650 may initiate a submission of the review entered in the review entry field 640, which may be selected from the pulldown menu 642. Accordingly, a user (e.g., user 152 or “Carolyn Smith”) may submit the review (e.g., from device 150) to the presentation machine 110, and the presentation machine 110 may subsequently present this review in the user interface 400.

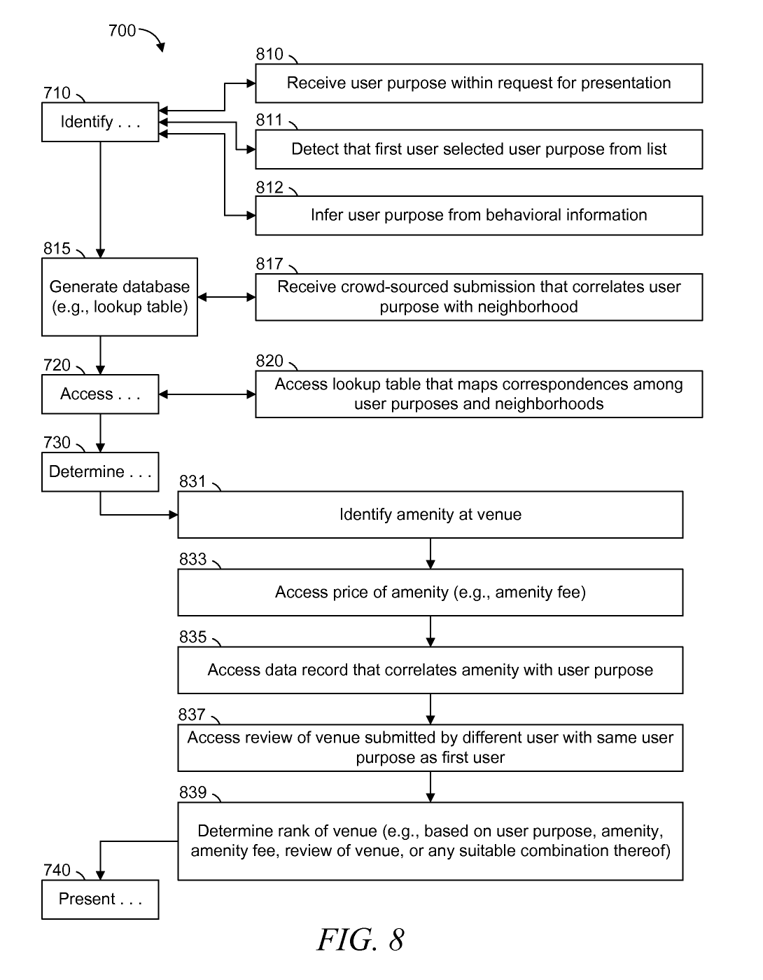

FIG. 7-8 are flowcharts illustrating operations of the presentation machine 110 in performing a method 700 of presenting a venue (e.g., by presenting a reference to the venue) based on its neighborhood within its city, according to some example embodiments. Operations in the method 700 may be performed using modules described above with respect to FIG. 2. As shown in FIG. 7, the method 700 includes operations 710, 720, 730, and 740.

In operation 710, the identification module 210 identifies a user purpose of the user 132. As noted above, the user purpose may be a purpose of the user 132 in submitting a request for a presentation of venues that are located within a city (e.g., San Francisco). In some example embodiments, the request may take the form of a query submitted to identify and present venues that are located within the city. As also noted above, the user purpose may be identified by accessing a user preference (e.g., from a user profile) of the user 132, receiving the user purpose from the user 132 (e.g., via device 130), determining the user purpose based on behavioral information (e.g., data that describes a behavior of the user 132, a behavior of a socially networked friend of the user 132, or both), or any suitable combination thereof. For example, the identification module 210 may identify the user purpose as being “business.”

In operation 720, the neighborhood module 220 accesses the database 115 which may correlate the user purpose (e.g., identified in operation 710) with a neighborhood that lies within the city. In some example embodiments, the database 115 may correlate the user purpose with the neighborhood by storing a data record that correlates the user purpose with the neighborhood (e.g., data record that references the user purpose and the neighborhood or indicates that the user purpose corresponds to the neighborhood). For example, the database 115 may correlate “business,” as a user purpose, with a neighborhood named “Financial District” within the city.

In operation 730, the venue module 230 determines a venue (e.g., a hotel named “Executive Enclave”) among multiple venues located within the city (e.g., hotels named “Big Cheese Inn” and “Clark Conference Center”). The venue module 230 may determine the venue based on the venue being located within the neighborhood that is correlated with the user purpose by the database 115. That is, operation 730 may be performed based on the venue being located within the neighborhood.

In operation 740, the presentation module 290 presents the venue to the user 132, who has the user purpose identified in operation 710 (e.g., “business”) for being within the city. The presentation module 290 may present the venue by presenting the reference 411 to the venue (e.g., a search result for a hotel named “Executive Enclave”) within the user interface 400. Operation 740 may be performed in response to the request for the presentation of venues, discussed above with respect to operation 710. Accordingly, the venue is presented to the user 132 based on the neighborhood in which the venue is located.

In some example embodiments, operation 740 may be performed based on the venue being located within a threshold distance of another venue (e.g., a further venue) within the same neighborhood. For example, the reference 411 to a hotel named “Executive Enclave” may be presented based on the hotel being located within a threshold distance (e.g., a distance of two blocks within a threshold distance of five blocks) from a street nicknamed “Bankers Row” in a neighborhood known as the “Financial District” of the city.

As shown in FIG. 8, the method 700 may include one or more of operations 810, 811, 812, 815, 817, 820, 831, 833, 835, 837, and 839. As shown, one or more of operations 810-812 may be performed as part (e.g., a precursor task, a subroutine, or a portion) of operation 710, in which the identification module 210 identifies the user purpose of the user 132.

In operation 810, the identification module 210 receives the user purpose within the request for the presentation of venues, discussed above with respect to operation 710. For example, the identification module 210 may receive a query submitted from the device 130 via the user interface 300, and the user purpose of the user 132 may be have been entered in the query using the user purpose field 320.

In operation 811, the identification module 210 detects that the user 132 has selected the user purpose from among a set of user purposes for being within the city. For example, the identification module 210 may identify the user purpose as being one of the selectable options (e.g., “business”) in the pulldown menu 322 of the user interface 300 and thus detect that the user 132 has selected the user purpose (e.g., “business”) from the pulldown menu 322.

In operation 812, the identification module 210 determines (e.g., infers) the user purpose based on behavioral information (e.g., data that describes a behavior of the user 132, a behavior of a socially networked friend of the user 132, or both). As noted above, a user that chooses to fly in business class a majority of the time is likely to be a business traveler with “business” as her user purpose, and a user whose first-degree friends all take single-traveler trips to the same destinations at the same times as the user himself is likely to be a recreational traveler with “adventure” as his user purpose. In some example embodiments, the user purpose may be determined (e.g., inferred) based on a query. For example, the identification module 210 may determine that a user whose query specifies a room for one person, arriving midweek (e.g., on Tuesday), for a one-night stay in New York City, is traveling for “business” reasons. As another example, the identification module 210 may determine that a user whose query specifies a room for two people, arriving on a Friday before a Monday holiday (e.g., a long weekend), for a two-night stay in Paris, is traveling for “romance” reasons. As a further example, the identification module 210 may determine that a user whose query specifies a room for four people (e.g., two adults and two children), arriving on a weekend (e.g., Saturday or Sunday), departing on a weekend, for a 1-week stay in Hawaii, is traveling for “family” reasons.

Operation 815 may be performed prior to operation 720, in which the neighborhood module 220 accesses the database 115. In operation 815, the neighborhood module 220 generates the database 115 or one or more portions (e.g., data records) thereof. For example, the neighborhood module 220 may generate the database 115 as a lookup table that maps (e.g., correlates) correspondences among multiple user purposes and multiple neighborhoods within the city. In some example embodiments, generation of the database 115 (e.g., generation of the lookup table) is based on one or more crowd-sourced submissions (e.g., submitted reports from users) that characterize various neighborhoods within the city as being suitable (e.g., appropriate) or unsuitable (e.g., inappropriate) for various user purposes.

In situations where a neighborhood is characterized by a venue that is correlated with the user purpose, the neighborhood module 220 may generate the database 115 based on the venue being within the neighborhood and correlated with the user purpose. For example, if a neighborhood called “Fisherman's Wharf” is characterized by “Pier 39,” and “Pier 39” is correlated with the user purpose of “family,” generation of the database 115 may map the neighborhood of “Fisherman's Wharf” to the user purpose of “family.” In example embodiments in which a neighborhood is correlated with a user purpose, the presenting of the venue in operation 740 may be performed based on the user purpose that is correlated with the neighborhood. Accordingly, performance of operation 740 may present the venue to the user 132 based on the neighborhood in which the venue is located being correlated with the user purpose of the user 132.

Operation 817 may be performed as part of operation 815. In operation 817, the neighborhood module 220 receives a crowd-sourced submission that correlates the user purpose with a neighborhood of the city. For example, the neighborhood module 220 may receive a user-submitted report that correlates the user purpose of “business” with a neighborhood named “Financial District” within the city.

Operation 820 may be performed as part of operation 720, in which the neighborhood module 220 accesses the database 115. In operation 820, the neighborhood module 220 accesses a lookup table discussed above with respect to operation 815. As noted above, the lookup table may map correspondences among multiple user purposes (e.g., “business” and “family”) and multiple neighborhoods (e.g., “Financial District” and “Fisherman's Wharf”) within the city.

One or more of operations 831, 833, 835, 837, and 839 may be performed before operation 740, in which the presentation module 290 presents the venue to which the reference 411 refers (e.g., a hotel named “Executive Enclave”). In operation 831, the amenity module 240 identifies an amenity at the venue determined in operation 730. As noted above, amenities of a venue, along with any corresponding amenity fees, may be identified by accessing information describing the venue (e.g., a webpage, a database, an advertisement, or any suitable combination thereof). In example embodiments that include operation 831, operation 740 may be based on the amenity identified in operation 831. For example, the venue may be ranked based on the existence of the amenity at the venue.

In operation 833, the amenity module 240 accesses a price (e.g., cost or fee) of the amenity identified in operation 831. For example, the amenity module 240 may access an amenity fee of the amenity. In some example embodiments, the amenity module 240 accesses a single price (e.g., cost or fee) for a group (e.g., bundle or package) of amenities at the venue. In example embodiments that include operation 833, operation 740 may be performed based on the amenity fee of the amenity at the venue. For example, the venue may be ranked based on the amenity fee for using the amenity at the venue.

In operation 835, the amenity module 240 accesses a data record (e.g., from the database 115) that correlates the amenity identified in operation 831 with the user purpose identified in operation 710 (e.g., “business”). According to various example embodiments, the database 115 may store one or more of such data records and hence may map various amenities to various user purposes. For example, amenities such as Internet access, a conference room, and a business center may be mapped to the user purpose of “business,” while amenities such as a pool, video games, and childcare service may be mapped to the user purpose of “family.” In example embodiments that include operation 835, operation 740 may be performed based on the amenity being correlated with the user purpose by the data record.

In operation 837, the review module 250 accesses (e.g., from the database 115) a review of the venue (e.g., review 534). As noted above, the review may be submitted by a user (e.g., user 152), and the user that submitted the review (e.g., user 152) may have the same user purpose (e.g., “business”) as a user to whom the user interface 400 is presented (e.g., user 132). Accordingly, the review may correspond to that user purpose (e.g., “business”). In example embodiments that include operation 837, operation 740 may be performed based on the review corresponding to the user purpose (e.g., “business”) being shared in common by the user that submitted the review (e.g., user 152) and the user to which the venue is presented in operation 740 (e.g., user 132).

In operation 839, the amenity module 240 determines a rank of the venue. The rank of the venue may be determined based on the venue's neighborhood, the user purpose identified in operation 710, a user purpose mapped to the venue (e.g., by the database 115), the presence of an amenity at the venue, a price of the amenity (e.g., amenity fee) at the venue, a review of the venue (e.g., one or more of the reviews 534, 536, and 538), or any suitable combination thereof. In example embodiments that include operation 839, operation 740 may be performed based on the rank of the venue, as determined in operation 839. Hence, the presenting of the venue in operation 740 may be performed based on the venue's neighborhood, the user purpose identified in operation 710, a user purpose mapped to the venue (e.g., by the database 115), the presence of an amenity at the venue, a price of the amenity (e.g., amenity fee) at the venue, a review of the venue (e.g., one or more of the reviews 534, 536, and 538), or any suitable combination thereof. In some of these example embodiments, operation 740 includes presenting the venue with the rank of the venue (e.g., within the user interface 400). In certain example embodiments, operation 740 includes presenting the venue grouped with other venues by neighborhood (e.g., within the user interface 400).

According to various example embodiments, one or more of the methodologies described with respect to FIG. 7-8 may facilitate presentation of the venue based on its neighborhood. Moreover, one or more of the methodologies described with respect to FIG. 7-8 may facilitate identification of venues, neighborhoods, or both, based on the user purpose of the user for being within a particular city. Hence, one or more the methodologies described with respect to FIG. 7-8 may facilitate generation and presentation of suggestions, recommendations, or decisions regarding one or more venues and their suitability for a particular user purpose.

When these effects are considered in aggregate, one or more of the methodologies described with respect to FIG. 7-8 may obviate a need for certain efforts or resources that otherwise would be involved in presenting a venue. Efforts expended by a user in identifying venues suitable for a particular user purpose may be reduced by one or more of the methodologies described with respect to FIG. 7-8. Computing resources used by one or more machines, databases, or devices (e.g., within the network environment 100) may similarly be reduced. Examples of such computing resources include processor cycles, network traffic, memory usage, data storage capacity, power consumption, and cooling capacity.

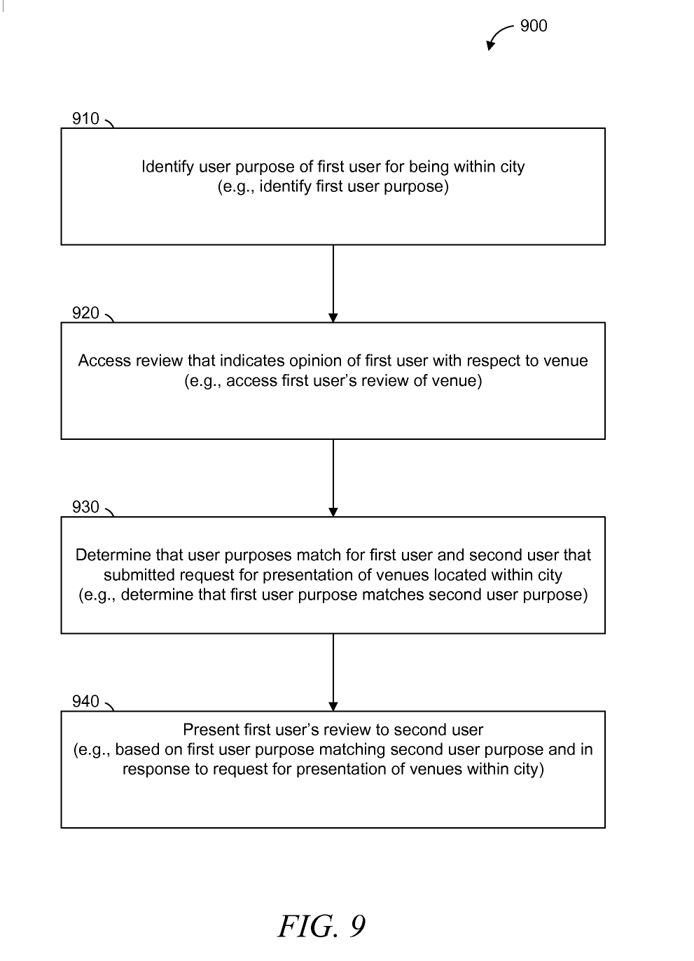

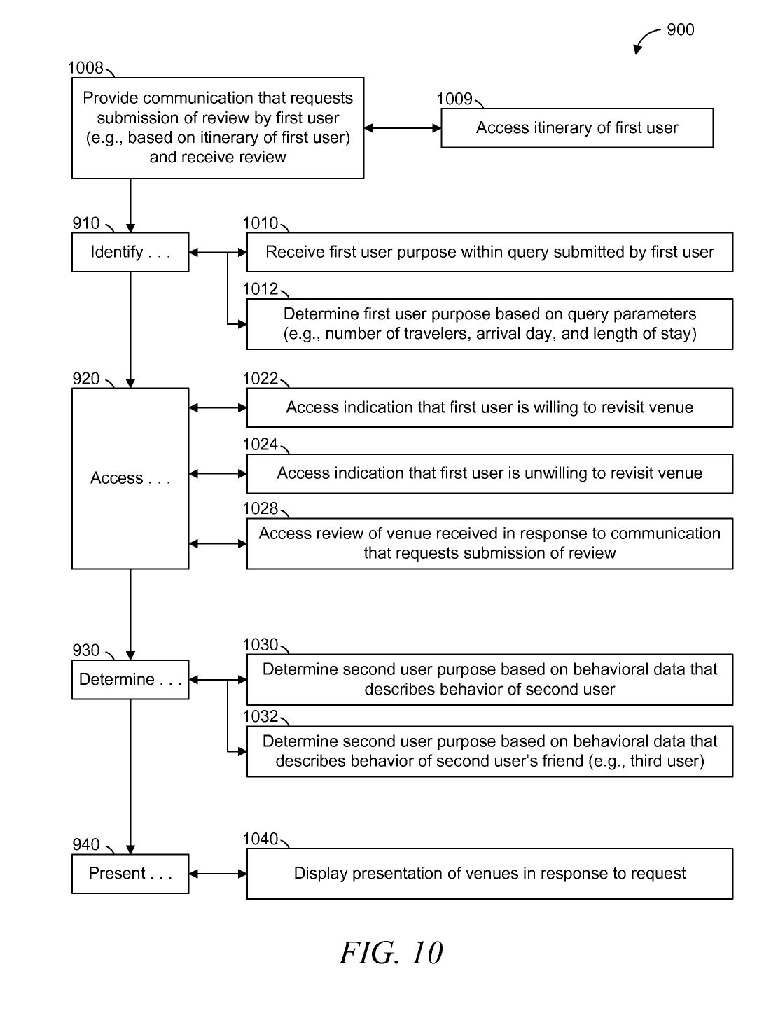

FIG. 9-10 are flowcharts illustrating operations of the presentation machine 110 in performing a method 900 of presenting a review of a venue (e.g., review 534) based on a user purpose (e.g., user purpose 420, “business”), according to some example embodiments. Operations in the method 900 may be performed using modules described above with respect to FIG. 2. As shown in FIG. 9, the method 900 includes operations 910, 920, 930, and 940.

In operation 910, the identification module 210 identifies a user purpose of the user 152 (e.g., “Carolyn Smith” or a first user). The user purpose may be a purpose of the user 152 for being within a city (e.g., San Francisco), for submitting a request for a presentation of venues that are located within the city, or both. As noted above, the user purpose may be identified by accessing a user preference (e.g., from a user profile) of the user 152, receiving the user purpose from the user 152 (e.g., via device 150), determining the user purpose based on behavioral information (e.g., data that describes a behavior of the user 152, a behavior of a socially networked friend of the user 152, or both), or any suitable combination thereof. For example, the identification module 210 may identify the user purpose as being “business.”

In operation 920, the review module 250 accesses a review (e.g., review 534) that indicates an opinion of the user 152 with respect to the venue (e.g., a hotel named “Executive Enclave”). For example, the review may be stored within the database 115, and the review module 250 may access the review from the database 115.

In operation 930, the match module 260 determines that the user purpose identified in operation 910 (e.g., “business”) matches a user purpose of the user 132 in submitting a request for a presentation of venues that are located within the city (e.g., San Francisco). For example, the user purpose for both users 132 and 152 may be “business.” According to various example embodiments, the user purpose of the user 132 may be identified using one or more the methodologies discussed above with respect to operation 710. In certain example embodiments, the user purpose of the user 132 is shared in common with a plurality of users (e.g., a majority of users of the network-based system 105).

In operation 940, the presentation module 290 presents the review (e.g., review 534) that indicates the opinion of the user 152. In particular, the presentation module 290 may present the review to the user 132 (e.g., via device 130). Moreover, the review may be presented based on operation 930. That is, the review may be presented based on the user purpose of one user (e.g., user 152) matching the user purpose of the other user (e.g., user 132). For example, the review 534 may be presented based on the user purpose for both users 132 and 152 being “business.” Operation 940 may be performed in response to the request for the presentation of venues submitted by the user 132. Accordingly, the review (e.g., review 534) that indicates the opinion of the user 152 may be presented to the user 132 based on the matching of the user purposes for the users 132 and 152.

As shown in FIG. 10, the method 900 may include one or more of operations 1008, 1009, 1010, 1012, 1022, 1024, 1028, 1030, 1032, and 1040. As shown, operation 1008 may be performed prior to operation 910, in which the identification module 210 identifies the user purpose of the user 152. In operation 1008, the review module 250 prompts the user 152 to provide the review, for example, by providing a communication that requests submission of the review of the venue by the user 152. An example of such a communication (e.g., user interface 600) is described above with respect to FIG. 6. Moreover, operation 1008 may include receiving the requested review (e.g., from the device 150 of the user 152, in response to the communication that requests submission of the review) and storing the received review in the database 115. In example embodiments that include operation 1008, operation 1028 may be performed as part of operation 920, in which the review is accessed by the review module 250. In operation 1028, the review module 250 accesses the review from the database 115 that stores the review received in response to the communication provided in operation 1008.

Operation 1009 may be performed as part (e.g., a precursor task, a subroutine, or a portion) of operation 1008, in which the review module 250 prompts the user 152 to provide the review. In operation 1009, the review module 250 accesses an itinerary of the user 152. For example, the database 115 may store the itinerary of the user 152, and the review module 250 may access the itinerary from the database 115. In example embodiments that include operation 1009, operation 1008 may be performed based on the itinerary of the user 152. For example, the review module 250 may communicate the user interface 600, which may include one or more of the notifications 601, 602, and 603, which in turn may be generated based on the itinerary of the user 152. The review module 250, in performing operation 1008, may generate and communicate the user interface 600, including one or more the notifications 601, 602, and 603. In some example embodiments, the itinerary of the user 152 indicates a time period during which the user 152 is scheduled to experience a layover while traveling. In such example embodiments, operation 1008 may be performed within this time period. In certain example embodiments, the itinerary of the user 152 indicates a final day of a stay at an accommodation (e.g., a hotel named “Executive Enclave”). In such example embodiments, operation 1008 may be performed on the final day of the stay (e.g., during check-out time or within an hour afterward). In various example embodiments, the itinerary of the user 152 indicates a first night of a stay at an accommodation. In such example embodiments, operation 1008 may be performed after the first night of the stay (e.g., in the morning on the second day of the stay).

One or more of operations 1010 and 1012 may be performed as part of operation 910, in which the identification module 210 identifies the user purpose (e.g., “business”) of the user 152 (e.g., “Carolyn Smith” or the first user). In operation 1010, the identification module 210 receives the user purpose within a request by the user 152 for a presentation of venues. This may be performed in a manner similar to operation 810. For example, the identification module 210 may receive a query submitted from the device 150 via the user interface 300, and the user purpose of the user 152 may be have been entered in the query using the user purpose field 320.

In some example embodiments, operation 910 in the method 900 includes an operation similar to operation 811 in the method 700. In particular, the identification module 210 may detect that the user 152 has selected the user purpose from among a set of user purposes for being within the city. For example, the identification module 210 may identify the user purpose as being one of the selectable options (e.g., “business”) in the pulldown menu 322 of the user interface 300 and thus detect that the user 152 has selected the user purpose (e.g., “business”) from the pulldown menu 322.

In operation 1012, the identification module 210 determines the user purpose based on one or more query parameters included within a query that is submitted by the user 152, based on behavioral information, or any suitable combination thereof. This may be performed in a manner similar to that described above with respect to operation 812 of the method 700. In particular, the identification module 210 may determine (e.g., infer) the user purpose based on behavioral information (e.g., data that describes a behavior of the user 152, a behavior of a socially networked friend of the user 152, or both). As noted above, a user that chooses to fly in business class a majority of the time is likely to be a business traveler with “business” as her user purpose, and a user whose first-degree friends all take single-traveler trips to the same destinations at the same times as the user himself is likely to be a recreational traveler with “adventure” as his user purpose. In some example embodiments, the user purpose may be determined (e.g., inferred) based on a query. For example, the identification module 210 may determine that a user whose query specifies a room for one person, arriving midweek (e.g., on Tuesday), for a one-night stay in New York City, is traveling for “business” reasons. As another example, the identification module 210 may determine that a user whose query specifies a room for two people, arriving on a Friday before a Monday holiday (e.g., a long weekend), for a two-night stay in Paris, is traveling for “romance” reasons. As a further example, the identification module 210 may determine that a user whose query specifies a room for four people (e.g., two adults and two children), arriving on a weekend (e.g., Saturday or Sunday), departing on a weekend, for a 1-week stay in Hawaii, is traveling for “family” reasons.

One or more of operations 1022, 1024, and 1028 may be performed as part of operation 920, in which the review module 250 accesses the review of the venue (e.g., review 534). Operation 1028 is described above in the discussion of operation 1008.

In operation 1022, the review module 250 accesses the review by accessing an indication (e.g., stored in the database 115) that the user 152 is willing to revisit the venue. For example, the review module 250 may access the positive review 644 (e.g., “Loved it! Would repeat!”). In some example embodiments, this indication is one of multiple mutually exclusive options that indicate an extent to which the user 152 is willing to use the venue in the future. For example, the indication may be one of two mutually exclusive options that indicate whether the user 152 is willing to use the venue in the future (e.g., a binary choice between “yes, I would return here” and “no, I would not return here”). In certain example embodiments, this indication is a score that is above a threshold value for willingness to revisit the venue (e.g., four out of five stars).

In operation 1024, the review module 250 accesses the review by accessing an indication (e.g., stored in the database 115) that the user 152 is unwilling to revisit the venue. For example, the review module 250 may access the negative review 646 (e.g., “Yuck! Would NOT repeat!”). In some example embodiments, this indication is one of two mutually exclusive options that indicate whether the user 152 is willing to use the venue in the future. In certain example embodiments, this indication is a score that is below a threshold value for willingness to revisit the venue (e.g., two out of five stars).

One or more of operations 1030 and 1032 may be performed as part of operation 930, in which the match module 260 determines that the user 132 and 152 have matching user purposes (e.g., “business”). As noted above, a user that chooses to fly in business class a majority of the time is likely to be a business traveler with “business” as her user purpose, and a user whose first-degree friends all take single-traveler trips to the same destinations at the same times as the user himself is likely to be a recreational traveler with “adventure” as his user purpose. In operation 1030, the match module 260 determines the user purpose of the user 132 based on behavioral data that describes a behavior of the user 132. In operation 1032, the match module 260 determines the user purpose of the user 132 based on behavioral data that describes a behavior of another user (e.g., a third user) that is socially networked to the user 132.

In some example embodiments, operation 1030 may be performed based on a query submitted by the user 132. For example, the match module 260 may determine that a user whose query specifies a room for one person, arriving midweek (e.g., on Tuesday), for a one-night stay in New York City, is traveling for “business” reasons. As another example, the match module 260 may determine that a user whose query specifies a room for two people, arriving on a Friday before a Monday holiday (e.g., a long weekend), for a two-night stay in Paris, is traveling for “romance” reasons. As a further example, the match module 260 may determine that a user whose query specifies a room for four people (e.g., two adults and two children), arriving on a weekend (e.g., Saturday or Sunday), departing on a weekend, for a 1-week stay in Hawaii, is traveling for “family” reasons.

Operation 1040 may be performed as part of operation 940, in which the presentation module 290 presents the review (e.g., review 534) that indicates the opinion of the user 152 with respect to the venue (e.g., a hotel named “Executive Enclave”). In operation 1040, the presentation module 290 generates the presentation of venues to include the review of the venue. For example, the presentation module 290 may generate the user interface 400 with the review 534, as depicted in FIG. 5. In example embodiments that include operation 1040, operation 940 may include displaying the presentation of venues (e.g., user interface 400) with the review (e.g., review 534). The presentation of venues may be displayed to the user 132 (e.g., via device 130).

According to various example embodiments, one or more of the methodologies described with respect to FIG. 9-10 may facilitate presentation (e.g., display) of a review based on a user purpose. Moreover, one or more of the methodologies described with respect to FIG. 9-10 may facilitate presentation of one or more aggregate reviews (e.g., reviews 536 and 538) based on a user purpose. Furthermore, one or more the methodologies described with respect to FIG. 9-10 may facilitate prompting a user to submit a review of the venue, where the review is correlated with a user purpose for using the venue.

When these effects are considered in aggregate, one or more of the methodologies described with respect to FIG. 9-10 may obviate a need for certain efforts or resources that otherwise would be involved in presenting a review based on a user purpose. Efforts expended by users in submitting and accessing reviews that correspond to a user purpose may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 11 is a block diagram illustrating components of a machine 1100, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 11 shows a diagrammatic representation of the machine 1100 in the example form of a computer system and within which instructions 1124 (e.g., software, a program, an application, an applet, an app, or other executable code) for causing the machine 1100 to perform any one or more of the methodologies discussed herein may be executed, in whole or in part. In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include a collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The machine 1100 may further include a graphics display 1110 (e.g., a plasma display panel (PDP), a light emitting diode (LED) display, a liquid crystal display (LCD), a projector, or a cathode ray tube (CRT)). The machine 1100 may also include an alphanumeric input device 1112 (e.g., a keyboard), a cursor control device 1114 (e.g., a mouse, a touchpad, a trackball, a joystick, a motion sensor, or other pointing instrument), a storage unit 1116, a signal generation device 1118 (e.g., a speaker), and a network interface device 1120.

The storage unit 1116 includes a machine-readable medium 1122 on which is stored the instructions 1124 embodying any one or more of the methodologies or functions described herein. The instructions 1124 may also reside, completely or at least partially, within the main memory 1104, within the processor 1102 (e.g., within the processor's cache memory), or both, during execution thereof by the machine 1100. Accordingly, the main memory 1104 and the processor 1102 may be considered as machine-readable media. The instructions 1124 may be transmitted or received over a network 1126 (e.g., network 190) via the network interface device 1120.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 1100), such that the instructions, when executed by one or more processors of the machine (e.g., processor 1102), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions define various example embodiments of methods, machine-readable media, and systems (e.g., apparatus) discussed herein:

1. A method comprising:

identifying a user purpose of a user,
the user purpose being a purpose of the user in submitting a request for a presentation of venues that are located within a city;
accessing a database that correlates the user purpose with a neighborhood that lies within the city;
determining a venue among the venues located within the city based on the venue being located within the neighborhood that is correlated with the user purpose by the database,
the determining of the venue being performed by a processor of a machine; and
presenting the venue to the user in response to the request for the presentation of venues that are located within the city.

2. The method of description 1, wherein:

the identifying of the user purpose includes receiving the user purpose within the submitted request for the presentation of venues.

3. The method of description 1 or description 2, wherein:

the identifying of the user purpose includes detecting that the user has selected the user purpose from among a set of user purposes for being within the city.

4. The method of any of descriptions 1-3, wherein:

the accessing of the database includes accessing a lookup table that maps correspondences among multiple user purposes and multiple neighborhoods within the city.

5. The method of any of descriptions 1-4 further comprising:

generating the database that correlates the user purpose with the neighborhood.

6. The method of description 5, wherein:

the generating of the database is based on reception of a submission that correlates the user purpose with the neighborhood of the city.

7. The method of description 5, wherein:

the generating of the database is based on the venue being within the neighborhood and correlated with the user purpose.
8. The method of any of descriptions 1-7, wherein:
the presenting of the venue is based on the venue being located within a threshold distance from a further venue within the neighborhood.

9. The method of any of descriptions 1-8, wherein:

the presenting of the venue is based on the user purpose that is correlated with the neighborhood of the city.

10. The method of any of descriptions 1-9 further comprising:

determining a rank of the venue based on the user purpose; and wherein the presenting of the venue includes presenting the venue with the rank of the venue.

11. The method of description 10, wherein:

the determining of the rank of the venue is based on a review of the venue submitted by a further user identified as having (e.g., sharing) the user purpose of the user (e.g., the same user purpose as the user); and
the presenting of the venue is based on the review submitted by the further user that has the user purpose of the user.

12. The method of any of descriptions 1-11 further comprising:

identifying an amenity at the venue; and wherein the presenting of the venue is based on the amenity at the venue.

13. The method of description 12, wherein:

the amenity at the venue has a corresponding amenity fee; and
the presenting of the venue is based on the amenity fee.

14. The method of description 12 or description 13 further comprising:

accessing a data record that correlates the amenity with the user purpose; and wherein
the presenting of the venue is based on the amenity being correlated with the user purpose by the data record.

15. The method of description 12 further comprising:

determining a rank of the venue based on a price of the amenity at the venue and based on the user purpose; and wherein
the presenting of the venue is based on the rank of the venue.

16. The method of any of descriptions 1-15, wherein:

the user purpose is selected from a group consisting of business, family, straight romance, gay romance, and adventure.

17. A non-transitory machine-readable storage medium comprising instructions that, when executed by one or more processors of a machine, cause the machine to perform operations comprising:

identifying a user purpose of a user,
the user purpose being a purpose of the user in submitting a request for a presentation of venues that are located within a city;
accessing a database that correlates the user purpose with a neighborhood that lies within the city;
determining a venue among the venues located within the city based on the venue being located within the neighborhood that is correlated with the user purpose by the database,
the determining of the venue being performed by the one or more processors of the machine; and
presenting the venue to the user in response to the request for the presentation of venues that are located within the city.

18. The non-transitory machine-readable storage medium of description 17, wherein the operations further comprise:

determining a rank of the venue based on the user purpose; and wherein the presenting of the venue includes presenting the venue with the rank of the venue.

19. A system comprising:

an identification module configured to identify a user purpose of a user,
the user purpose being a purpose of the user in submitting a request for a presentation of venues that are located within a city;
a neighborhood module configured to access a database that correlates the user purpose with a neighborhood that lies within the city;
a processor configured by a venue module to determine a venue among the venues located within the city based on the venue being located within the neighborhood that is correlated with the user purpose by the database; and
a presentation module configured to present the venue to the user in response to the request for the presentation of venues that are located within the city.

20. The system of description 19 further comprising:

an amenity module configured to access a price of an amenity at the venue; and wherein
the presentation module is configured to present the venue based on the price of the amenity at the venue.

21. A method comprising:

identifying a first user purpose of a first user,
the first user purpose being a first purpose of the first user for being within a city; accessing a review of a venue that is located within the city,
the review of the venue indicating an opinion of the first user with respect to the venue;
determining that the first user purpose of the first user matches a second user purpose of a second user that submitted a request for a presentation of venues that are located within the city,
the determining being performed by a processor of a machine; and
presenting the review that indicates the opinion of the first user to the second user, the presenting of the review being based on the first user purpose of the first user matching the second user purpose of the second user.

22. The method of description 21, wherein:

the identifying of the first user purpose of the first user includes receiving the first user purpose within a query that is submitted by the first user.

23. The method of description 21, wherein:

the identifying of the first user purpose includes determining the first user purpose based on parameters of a query that is submitted by the first user,
the parameters including a number of travelers, an arrival day of the week, and a number of days of a stay at an accommodation.

24. The method of any of descriptions 21-23, wherein:

the accessing of the review includes accessing an indication that the user is willing to revisit the venue that is subject to the review.

25. The method of any of descriptions 21-23, wherein:

the accessing of the review includes accessing an indication that the user is unwilling to revisit the venue that is subject to the review.

26. The method of any of descriptions 21-23, wherein:

the accessing of the review includes accessing one of multiple mutually exclusive options that indicate an extent to which the user is willing to use the venue in the future.

27. The method of any of descriptions 21-26, wherein:

the second user purpose is a second purpose of the second user for being within the city.

28. The method of any of descriptions 21-26, wherein:

the second user purpose is a second purpose of the second user in submitting the request for the presentation of venues.

29. The method of any of descriptions 21-28, wherein:

the determining that the first user purpose matches the second user purpose includes determining the second user purpose based on behavioral data that describes a behavior of the second user.

30. The method of any of descriptions 21-29, wherein:

the determining that the first user purpose matches the second user purpose includes determining the second user purpose based on behavioral data that describes a behavior of a third user that is socially networked to the second user.

31. The method of any of descriptions 21-30 further comprising:

generating the presentation of venues to include the review of the venue; and wherein
the presenting of the review includes displaying the presentation of venues.

32. The method of any of descriptions 21-31 further comprising:

providing a communication that requests submission of the review of the venue by the first user; and wherein
the accessing of the review of the venue is from a database that stores the review received in response to the communication.

33. The method of description 32, wherein:

the providing of the communication is based on an itinerary of the first user and includes accessing the itinerary of the first user.

34. The method of description 33, wherein:

the itinerary of the first user indicates a time period during which the first user is scheduled to experience a layover while traveling; and
the providing of the communication is performed within the time period.

35. The method of description 33 or description 34, wherein:

the itinerary of the first user indicates a final day of a stay at an accommodation; and
the providing of the communication is performed on the final day of the stay.

36. The method of any of descriptions 33-35, wherein:

the itinerary of the first user indicates a first night of a stay at an accommodation; and
the providing of the communication is performed after the first night of the stay.

37. A non-transitory machine-readable storage medium comprising instructions that, when executed by one or more processors of a machine, cause the machine to perform operations comprising:

identifying a first user purpose of a first user,
the first user purpose being a first purpose of the first user for being within a city; accessing a review of a venue that is located within the city,
the review of the venue indicating an opinion of the first user with respect to the venue;
determining that the first user purpose of the first user matches a second user purpose of a second user that submitted a request for a presentation of venues that are located within the city,
the determining being performed by the one or more processors of the machine; and
presenting the review that indicates the opinion of the first user to the second user, the presenting of the review being based on the first user purpose of the first user matching the second user purpose of the second user.

38. The non-transitory machine-readable storage medium of description 37, wherein:

the accessing of the review includes accessing one of two mutually exclusive options that indicate whether the user is willing to use the venue in the future.

39. A system comprising:

an identification module configured to identify a first user purpose of a first user, the first user purpose being a first purpose of the first user for being within a city;
a review module configured to access a review of a venue that is located within the city,
the review of the venue indicating an opinion of the first user with respect to the venue;
a processor configured by a match module to determine that the first user purpose of the first user matches a second user purpose of a second user that submitted a request for a presentation of venues that are located within the city; and
a presentation module configured to present the review that indicates the opinion of the first user to the second user,
the presenting of the review being based on the first user purpose of the first user matching the second user purpose of the second user.

40. The system of description 39, wherein:

the review module is configured to:
provide a communication that requests submission of the review of the venue by the first user; and
receive the review of the venue in response to the communication.

What is claimed is:

1. A method comprising:
identifying a first user purpose of a first user,
the first user purpose being a first purpose of the first user for being within a city;
accessing a review of a venue that is located within the city,
the review of the venue indicating an opinion of the first user with respect to the venue;
determining that the first user purpose of the first user matches a second user purpose of a second user that submitted a request for a presentation of venues that are located within the city,
the determining being performed by a processor of a machine; and
presenting the review that indicates the opinion of the first user to the second user,
the presenting of the review being based on the first user purpose of the first user matching the second user purpose of the second user.

2. The method of claim 1, wherein:
the identifying of the first user purpose of the first user includes receiving the first user purpose within a query that is submitted by the first user.

3. The method of claim 1, wherein:
the identifying of the first user purpose includes determining the first user purpose based on parameters of a query that is submitted by the first user,
the parameters including a number of travelers, an arrival day of the week, and a number of days of a stay at an accommodation.

4. The method of claim 1, wherein:
the accessing of the review includes accessing an indication that the user is willing to revisit the venue that is subject to the review.

5. The method of claim 1, wherein:
the accessing of the review includes accessing an indication that the user is unwilling to revisit the venue that is subject to the review.

6. The method of claim 1, wherein:
the accessing of the review includes accessing one of multiple mutually exclusive options that indicate an extent to which the user is willing to use the venue in the future.

7. The method of claim 1, wherein:
the second user purpose is a second purpose of the second user for being within the city.

8. The method of claim 1, wherein:
the second user purpose is a second purpose of the second user in submitting the request for the presentation of venues.

9. The method of claim 1, wherein:
the determining that the first user purpose matches the second user purpose includes determining the second user purpose based on behavioral data that describes a behavior of the second user.

10. The method of claim 1, wherein:
the determining that the first user purpose matches the second user purpose includes determining the second user purpose based on behavioral data that describes a behavior of a third user that is socially networked to the second user.

11. The method of claim 1 further comprising:
generating the presentation of venues to include the review of the venue; and wherein
the presenting of the review includes displaying the presentation of venues.

12. The method of claim 1 further comprising:
providing a communication that requests submission of the review of the venue by the first user; and wherein
the accessing of the review of the venue is from a database that stores the review received in response to the communication.

13. The method of claim 12, wherein:
the providing of the communication is based on an itinerary of the first user and includes accessing the itinerary of the first user.

14. The method of claim 13, wherein:
the itinerary of the first user indicates a time period during which the first user is scheduled to experience a layover while traveling; and
the providing of the communication is performed within the time period.

15. The method of claim 13, wherein:
the itinerary of the first user indicates a final day of a stay at an accommodation; and
the providing of the communication is performed on the final day of the stay.

16. The method of claim 13, wherein:
the itinerary of the first user indicates a first night of a stay at an accommodation; and
the providing of the communication is performed after the first night of the stay.

17. A non-transitory machine-readable medium comprising instructions that, when executed by one or more processors of a machine, cause the machine to perform operations comprising:
identifying a first user purpose of a first user,
the first user purpose being a first purpose of the first user for being within a city;
accessing a review of a venue that is located within the city,
the review of the venue indicating an opinion of the first user with respect to the venue;
determining that the first user purpose of the first user matches a second user purpose of a second user that submitted a request for a presentation of venues that are located within the city,
the determining being performed by the one or more processors of the machine; and
presenting the review that indicates the opinion of the first user to the second user,
the presenting of the review being based on the first user purpose of the first user matching the second user purpose of the second user.

18. The non-transitory machine-readable medium of claim 17, wherein:
the accessing of the review includes accessing one of two mutually exclusive options that indicate whether the user is willing to use the venue in the future.

19. A system comprising:
an identification module configured to identify a first user purpose of a first user,
the first user purpose being a first purpose of the first user for being within a city;
a review module configured to access a review of a venue that is located within the city,
the review of the venue indicating an opinion of the first user with respect to the venue;
a processor configured by a match module to determine that the first user purpose of the first user matches a second user purpose of a second user that submitted a request for a presentation of venues that are located within the city; and
a presentation module configured to present the review that indicates the opinion of the first user to the second user,
the presenting of the review being based on the first user purpose of the first user matching the second user purpose of the second user.

20. The system of claim 19, wherein:
the review module is configured to:
provide a communication that requests submission of the review of the venue by the first user; and
receive the review of the venue in response to the communication.
